(19) United States
(12) Patent Application Publication
(10) Pub. No.: US 2001/0044038 A1
(43) Pub. Date: Nov. 22, 2001

(54) RECORDING MEDIUM SUBSTRATE AND RECORDING MEDIUM

(76) Inventor: OSAMU MORITA, MIYAGI (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/313,173

(22) Filed: May 18, 1999

(30) Foreign Application Priority Data
May 29, 1998 (JP) P10-150201

(51) Int. Cl. G11B 5/82

(52) U.S. Cl. 428/694 SG

(57) ABSTRACT

There are provided a recording medium substrate that is not expensive and less affected by external vibrations and a recording medium that comprises such a recording medium substrate and operate excellently for recording/reproducing data. The magnetic disk comprises a disk substrate and a magnetic film formed on the disk substrate. The disk substrate is produced by injection molding a metal material.

### BACKGROUND OF THE INVENTION

1. Field of the Invention

This invention relates to a recording medium substrate, a recording medium and a method of manufacturing the same. More particularly, the present invention relates to an improved material to be used for a recording medium substrate and a method of molding the same.

2. Related Background Art

The trend of down-sizing information recording apparatus is remarkable in recent years as notebook-sized personal computers are sold by an increasingly large number. Particularly, extremely thin magnetic disk units are commercially available to encourage the trend of down-sizing.

Notebook-sized personal computers are available at a remarkably low price level because of the severe competition of the market although they perform much better than their ancestors.

Under these circumstances, external storage units of computers are and will be required to be smaller and less expensive than ever. These requirements will be particularly rigorous to those to be used with notebook-sized personal computers because the latter inevitably comprise a display and a keyboard as principal components thereof.

Research efforts are being paid to develop thin and low cost magnetic disk units. Some specific aspects of these efforts will be discussed below.

Firstly, a very thin magnetic disk unit should not be realized at the cost of storage capacity because a magnetic disk unit with a small storage capacity will not be able to find any significant demand. Therefore, efforts are being paid to develop magnetic disk units that are thin and can densely store data.

For example, as a result of the recent development of magnetoresistive effect type magnetic heads, it is now possible to realize a recording density of 2 Gbit/sq.inch that has not been able to be achieved by conventional inductive type magnetic heads. With this technological development, conventional magnetic disk units containing a pair of disks have practically been replaced by magnetic disk units containing only a single disk so that consequently they can be made very thin.

According to another aspect of the research efforts for realizing very thin magnetic disk units, attempts have been made to reduce the thickness of the magnetic disks contained in them. More specifically, the magnetic disk contained in a magnetic disk unit used to be mostly about 1.2 mm thick but currently its thickness is reduced to 0.8 mm or even to 0.635 mm. The reduction in the thickness of the magnetic disk can consequently reduce the overall thickness of the magnetic disk unit.

Meanwhile, efforts are equally being paid to reduce the cost of manufacturing a magnetic disk unit. It will be appreciated that the cost of the magnetic head and that of the magnetic disk take a major part in the overall cost of a magnetic disk unit.

As for the magnetic head, magnetoresistive effect type magnetic heads have been in the mainstream for realizing high density recording. Currently, the use of a magnetoresistive effect type magnetic head in a magnetic disk unit is indispensable for high density recording. Thus, the only hope for reducing the cost of a magnetic head lies in manufacturing magnetoresistive effect type magnetic heads on a mass production basis.

As for the magnetic disk, on the other hand, magnetic disks comprising a disk substrate that is made of resin and produced by injection molding have been attracting attention because of low cost. Conventionally, however, aluminum substrates have most popularly been used as disk substrates. An aluminum substrate is typically prepared in a manner as described below.

Firstly, a piece of aluminum is cut out from a parent block of aluminum to show the profile of a substrate. Then, the surface of the aluminum substrate is subjected to a precision polishing process. The preciseness of the polishing operation is required because a flying slider comprising a magnetic disk and a magnetic head carried on the magnetic disk normally shows a flying height of about 50 nm. If the magnetic disk has projections on the surface that are more than 50 nm high, they can collide with the magnetic head to damage the magnetic disk and the magnetic head and give rise to disturbances in the information signals reproduced by the magnetic head.

Thus, the surface of the aluminum substrate has to be subjected to a precision polishing process. More specifically, a polishing step and a subsequent cleansing step are repeated to realize a very smooth surface for the aluminum substrate. As the polishing/cleansing cycle goes on, the particle size of the polishing powder is reduced. After a number of polishing/cleansing cycles, the surface will be smoothed and free from projections higher than 50 nm.

With such a method of preparing a disk substrate, it is highly difficult to reduce the manufacturing cost and provide a low cost magnetic disk because of the large number of polishing cleaning cycles required for polishing the surface of the substrate.

With a method of preparing a disk substrate of resin by injection molding, on the other hand, the obtained disk substrate does not need polishing and only the surface of the stamper to be used for injection molding should be polished to show a smooth surface with minimal undulations in order to produce a disk substrate with minimal surface projections because the surface of the stamper is directly reflected to the surface of the injection molded product.

With such an injection molding technique, the repetitive polishing/cleansing cycles necessary for preparing an aluminum disk substrate can be omitted to reduce the cost of manufacturing a disk substrate. Additionally, the cost per unit volume of resin is far lower than that of aluminum. Thus, resin disk substrates that can be produced by injection molding provide a great advantage relative to aluminum disk substrates.

As discussed above, a magnetic disk unit having a reduced thickness can be manufactured at low cost by resin injection molding and by reducing the thickness of the magnetic disk contained in it.

However, a resin disk substrate produced by injection molding is less rigid than a conventional glass or aluminum disk substrate and hence more easily affected by external vibrations than the latter. In other words, a resin disk substrate produced by injection molding shows a relatively low resonance frequency.

Therefore, a magnetic disk comprising a resin disk substrate is apt to resonate with a minute external vibration. Then, it is difficult to hold the magnetic head mounted on a flying slider properly in position on the right track in order to correctly retrieve the information signals on the track. Such a magnetic disk will inevitably by accompanied by a problem of a poor data recording/reproducing performance.

Generally, each magnetic disk has a natural vibration frequency specific to it. When a disturbing vibration having a frequency same as the natural vibration frequency is applied externally to the magnetic disk, the latter begins to resonate.

Particularly, a magnetic disk comprising a resin disk substrate has a small resonance frequency and hence resonates with a minute external vibration.

Once such resonance starts, the flying slider flying above the magnetic disk with a flying height of about 50 nm also starts resonating. The flying slider is not provided with any servo mechanism that can maintain its flying height at a constant level regardless of the vibration of the magnetic disk. Additionally, if the magnetic disk vibrates along the axial direction of the spindle, it vibrates also in a direction perpendicular to the axial direction of the spindle. Thus, it vibrates in an intra-planar direction of the disk to a certain extent.

Particularly, in magnetic disk units marketed in recent years, signals are recorded densely both in the direction of the tracks and in the direction transversal relative to the tracks in order to raise the recording density. In other words, the track width is reduced so that, when a vibration in an intra-planar direction of the magnetic disk exists, if slightly, such a vibration will not be negligible in terms of the data recording/reproducing performance of the magnetic disk unit. Then, it is difficult to hold the flying slider properly in position on the right track in order to correctly retrieve the information signals on the track. As pointed out above, such a magnetic disk will inevitably by accompanied by a problem of a poor data recording/reproducing performance.

Thus, it is necessary to minimize the vibration of the magnetic disk in order to ensure a high data recording/reproducing performance. In other words, a high data recording/reproducing performance can be realized by providing a magnetic disk that is hardly affected by external vibrations.

Therefore, techniques have been studied to reduce the vibration of a magnetic disk due to resonance. One of such techniques proposes to control the behavior of the spindle that can be an external source of disturbing vibrations to which the magnetic disk is subjected to. More specifically, with such a technique, the magnetic disk unit is provided with fluid bearing for the spindle in order to suppress or remove any undesired behavior on the part of the bearing.

While this technique can be used with conventional disk substrates, fluid bearing is more expensive than ordinary ball bearing. Additionally, the use of fluid bearing does not completely eliminate the external source of disturbing vibrations.

### SUMMARY OF THE INVENTION

Under the above described circumstances, it is therefore the object of the present invention to provide a recording medium substrate that is not expensive and less affected by external vibrations and also a recording medium that comprises such a recording medium substrate and operates excellently for recording/reproducing data.

According to an aspect of the invention, the above object is achieved by providing a recording medium substrate characterized by being made of a metal material and formed by injection molding. Preferably, the metal material contains at least magnesium or aluminum.

Since a recording medium substrate according to the invention and defined above is made of a metal material, it shows a sufficient hardness so that it is less affected by external vibrations and shows desired vibration characteristics. Additionally, since a recording medium substrate according to the invention is made of a metal material and formed by injection molding, it does not need a polishing step, unlike conventional substrates, and hence can be produced with a reduced number of molding steps at reduced cost.

Thus, a recording medium substrate according to the invention not only shows desired vibration characteristics but can be manufactured at low cost. From the viewpoint of hardness, melting point and thermal conductivity, the metal material to be used for injection molding preferably contains at least magnesium or aluminum.

According to another aspect of the invention, there is also provided a recording medium characterized by comprising a substrate made of a metal material and formed by injection molding and a recording film formed on said substrate. Preferably, the metal material contains at least magnesium or aluminum.

Since a recording medium according to the invention and defined above comprises a substrate made of a metal material, it shows a sufficient hardness so that it is less affected by external vibrations and shows desired vibration characteristics. Additionally, since the substrate of a recording medium according to the invention is made of a metal material and formed by injection molding, it does not need a polishing step, unlike conventional substrates, and hence can be produced with a reduced number of molding steps at reduced cost.

Thus, a recording medium according to the invention not only shows desired vibration characteristics but can be manufactured at low cost. From the viewpoint of hardness, melting point and thermal conductivity, the metal material to be used for injection molding preferably contains at least magnesium or aluminum.

### BRIEF DESCRIPTION OF THE DRAWINGS

FIG. 1 is a schematic perspective view of a magnetic disk realized by applying the present invention.

FIG. 2 is a schematic cross sectional view of part of the magnetic disk of FIG. 1.

FIG. 3 is a schematic plan view of another magnetic disk realized by applying the present invention.

FIG. 4 is an enlarged schematic plan view of the circled area X of the magnetic disk of FIG. 3.

FIG. 5 is a schematic cross sectional view of part of the magnetic disk of FIG. 3 taken along a radial direction of the disk.

FIG. 6 is a schematic cross sectional view of part of the magnetic disk of FIG. 3 taken along the direction of the tracks.

FIG. 7 is a schematic perspective view of part of the magnetic disk of FIG. 3, illustrating how the head slider flies over the magnetic disk.

FIG. 8 is a schematic perspective view of a principal portion of the head slider flying over the magnetic disk of FIG. 3.

FIG. 9 is a schematic cross sectional view of the head slider of FIG. 8, illustrating how it flies over the magnetic disk of FIG. 3.

FIG. 10 is a schematic cross sectional view of part of an optical disk unit.

FIG. 11 is a schematic cross sectional view of the metal mold of an injection molding apparatus that can be used for molding a recording medium substrate according to the invention.

FIG. 12 is a schematic cross sectional view of the metal mold of the injection molding apparatus of FIG. 11, illustrating a step of producing a recording medium substrate by injection molding.

FIG. 13 is another schematic cross sectional view of the metal mold of the injection molding apparatus of FIG. 11, illustrating another step of producing a recording medium substrate by injection molding.

FIG. 14 is still another schematic cross sectional view of the metal mold of the injection molding apparatus of FIG. 11, illustrating still another step of producing a recording medium substrate by injection molding.

FIG. 15 is still another schematic cross sectional view of the metal mold of the injection molding apparatus of FIG. 11, illustrating still another step of producing a recording medium substrate by injection molding.

FIG. 16 is still another schematic cross sectional view of the metal mold of the injection molding apparatus of FIG. 11, illustrating still another step of producing a recording medium substrate by injection molding.

FIG. 17 is a schematic block diagram of a vibration measuring system that can be used to observe the vibration characteristics of magnetic disks to which the present invention is applied.

FIG. 18 is a graph showing the results of observation obtained in Examples and a Comparative Example.

### DETAILED DESCRIPTION OF THE PREFERRED EMBODIMENTS

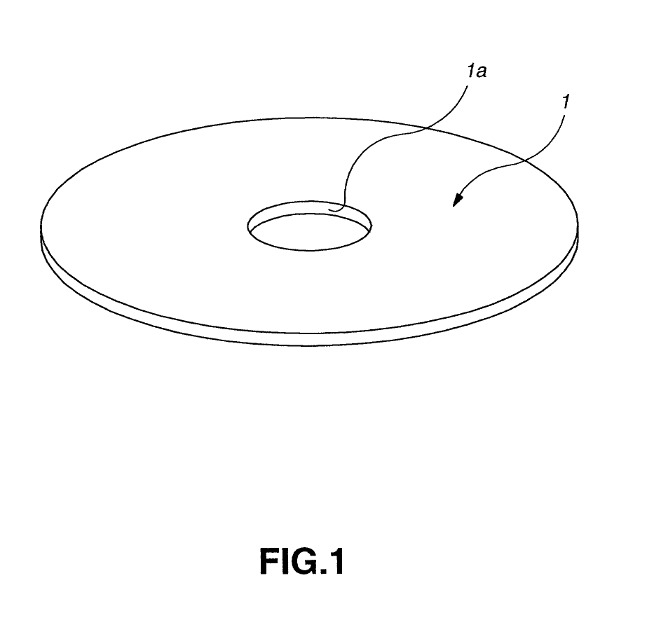

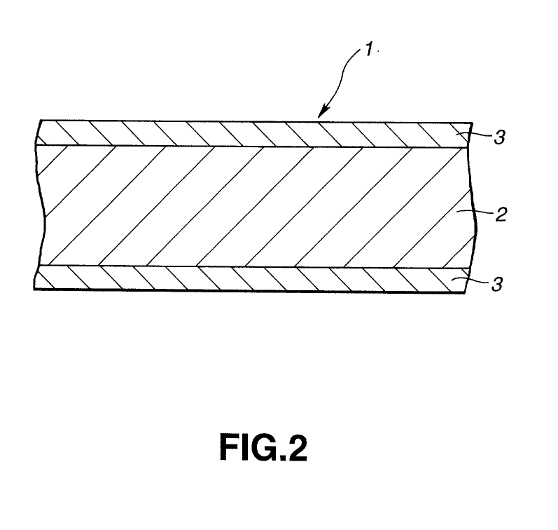

Now, the present invention will be described in greater detail by referring to the accompanying drawings that illustrate preferred embodiments of the invention. While magnetic disks will be described below as recording medium to which the present invention is applied, the present invention is by no means limited thereto as will be discussed hereinafter. FIG. 1 is a schematic perspective view of a magnetic disk realized by applying the present invention and FIG. 2 is a schematic cross sectional view of part of the magnetic disk of FIG. 1.

Referring to FIGS. 1 and 2, the magnetic disk 1 realized by applying the present invention comprises a disk substrate 2 and a pair of magnetic films 3 formed respectively on the opposite principal surfaces of the substrate 2. The magnetic disk 1 is provided with a central bore 1a at the center thereof. Note that the magnetic disk 1 may alternatively comprise only a single magnetic film formed on one of the principal surfaces of the disk substrate 2.

One of the characteristic features of the disk substrate 2 according to the invention is that it is made of a metal material and formed by injection molding. In other words, the disk substrate 2 is produced by injection molding a metal material.

Specifically, the metal material may contain metals such as magnesium, aluminum, titanium, nickel and iron. Preferably, the metal material contains at least magnesium or aluminum. More preferably, the metal material contains magnesium. Such a metal material is preferably used for the purpose of the invention because of the following reasons.

Known resin disk substrates are pliable and show a relatively low resonance. Therefore, known magnetic disks comprising a resin disk substrate can easily vibrate when a vibration is externally applied thereto so that they are apt to resonate with a minute external vibration. Then, it is difficult to hold the magnetic head mounted on a flying slider properly in position on the right track in order to correctly retrieve the information signals on the track. Such a magnetic disk will inevitably by accompanied by a problem of a poor data recording/reproducing performance.

Particularly, as pointed out above, in magnetic disk units marketed in recent years, signals are recorded densely both in the direction of the tracks and in the direction transversal relative to the tracks in order to raise the recording density. In other words, when the track width is reduced, if slightly, such a vibration will not be negligible in terms of intra-planar vibration of the magnetic disk resonating with the external vibration. In magnetic disk unit, servo information for holding the magnetic head properly in position on the right track is read out of the magnetic disk. However, if the servo information is read out correctly and the magnetic head is properly placed in position, the flying slider can be displaced from the proper position for reading information signals due to the vibration of the magnetic disk.

The flying slider is used to place in position the magnetic disk mounted on the flying slider. With the servo, however, since the vibration of the magnetic head has a finite frequency, the magnetic head cannot be placed properly in position on the right track if the track vibrates with a frequency higher than the finite frequency. Hereinafter, the frequency range from 0 Hz to the finite frequency will be referred to as serve band. Thus, the servo can be made to operate properly only when the track vibrates with a frequency found within the servo band. To the contrary, the servo cannot be made to operate properly when the track vibrates with a frequency found outside the servo band regardless of the cause of the vibration of the track.

Therefore, while the above problem can be solved basically by making the magnetic disk free from vibration, it can also be dissolved by selecting a vibration frequency found outside the servo band for the magnetic disk.

Generally, the amount of vibration energy is inversely proportional to the frequency of the vibration. Thus, if the magnetic disk has a high resonance frequency, the amplitude of vibration of the magnetic disk is very small and does not require the use of the servo for positioning of the magnetic head. In other words, the vibration is negligible.

Therefore, if the resonance frequency of the magnetic disk is made to be found outside the servo band of the magnetic disk unit containing the magnetic disk, the vibration of the magnetic disk in the intra-planar direction that is caused totally by a resonating vibration can be completely eliminated. If the resonance frequency of the magnetic disk is not completely pushed outside the servo band, the vibration of the magnetic disk that is caused by resonance can be minimized.

Normally, the natural vibration frequency of a disk-shaped object such as an information recording medium substrate is expressed by formula (1) below so long as the profile is not deformed:

fᵢ=G(E×t²/ρ)^{½} (1)

where fᵢ represents the natural vibration frequency, t represents the thickness of the substrate, ρ represents the density of the material of the substrate, E represent the Young's modulus of the material of the substrate and G represents the proportional constant.

As seen from formula (1) above, a high natural vibration frequency fᵢ can be obtained only by raising either the thickness of the disk substrate or the ratio of E/ρ. However, the thickness of the disk substrate should be reduced in order to meet the current trend of reducing the overall thickness of the magnetic disk unit. Therefore, the choice of raising the thickness of the disk substrate is not desirable from the viewpoint of developing magnetic disks of the next generation.

Therefore, selection of a material showing a large E/ρ ratio for the disk substrate 2 is desirable to raise the natural vibration frequency of the disk substrate 2 for the purpose of the invention. Now, preferable materials of the disk substrate 2 will be discussed by referring to Table 1 below.

TABLE 1

| | Young's | | | | thermal |
|---|---|---|---|---|---|
| | modulus Ε | density ρ | | melting | conductivity |
| | [Gpa] | [g/cc] | Ε/ρ | point [° C.] | [W/m° C.] |
| zinc | 108.4 | 7.12 | 15.2 | 419 | — |
| aluminum | 70.3 | 2.69 | 26.1 | 660 | 23.6 |
| cadmium | 49.9 | 8.64 | 5.77 | 321 | — |
| magnesium | 44.8 | 1.74 | 25.7 | 651 | 18.6 |
| titanium | 115.7 | 4.54 | 25.4 | 1675 | 4.5 |
| nickel | 219.2 | 8.85 | 24.8 | 1455 | 10.6 |
| iron | 205.8 | 7.90 | 26.0 | 1535 | 74.6 |
| resin | 2.4 | 1.01 | 2.4 | 140 | 0.18 |
| glass | 75.0 | 2.2 | 34.1 | 1600 | 1.3 |

As clearly seen from Table 1 above, glass shows the largest value of 34.1 for the ratio of E/ρ. On the other hand, resin shows the smallest value of 2.4 for the ratio of E/ρ. Aluminum that is currently used for disk substrates shows a relatively large value of 26.1 for the ratio of E/ρ among the materials that can be used for disk substrates.

Thus, a material having a value greater than aluminum for the ratio of E/ρ will advantageously be used for a disk substrate that effectively suppresses the vibration that may appear during the data recording/reproduction operation. Such a material will show improved vibration characteristics more than any currently available magnetic disks.

Therefore, materials that can advantageously be used for the disk substrate of a recording medium include magnesium, titanium, glass, nickel and iron in addition to aluminum.

However, it should be noted that nickel and iron have to be excluded from the above list of materials good for the disk substrate of a recording medium such as a magnetic disk or a magneto-optical disk where the magnetic characteristics are utilized for the recording operation.

Then, of the materials listed above, those that can be used with injection molding as low cost substrate producing process will have to be selected as advantageous candidate materials. The requirements to be met to make a material suited for injection molding include the following.

Firstly, the material to be suitably used for injection molding has to show a relatively low melting point. In the injection molding process, the material is molten and poured into a metal mold. Thus, if the material has a very high melting point, the metal mold itself can be thermally deformed when the molten material is poured into it. From the viewpoint of this requirement, materials having a melting point higher than 1,000° C. will not be practically feasible. Thus, titanium, nickel, iron and glass have to be excluded from the above list.

Secondly, the material to be suitably used for injection molding has to show a relatively small thermal conductivity. In the injection molding process, the molten material starts cooling the instance when it is poured into the metal mold. Thus, if the material has a very large thermal conductivity, it can starts becoming solidified before it is completely poured into the metal mold to leave resin flow marks on the surface of the molded product. Then, the product may not show the desired profile.

From the viewpoint of thermal conductivity, magnesium shows a thermal conductivity smaller than aluminum as seen from Table 1 so that the former is more suited for injection molding than the latter.

It will also be seen from Table 1 that magnesium has a density smaller than aluminum and hence an object of magnesium will be lighter than another object having the same profile and made of aluminum. Thus, a magnetic disk 1 comprising a magnesium-made disk substrate 2 will be lighter than a magnetic disk 1 comprising an aluminum-made disk substrate 2 and the motor torque necessary for driving the magnetic disk to rotate will be smaller for the former than for the latter. Then, the power consumption rate of the former will be smaller than that of the latter to a great advantage of a battery-driven notebook-sized personal computer adapted to use a magnetic disk comprising a magnesium-made disk substrate because it can be operated without replacing the battery for a prolonged time. In short, a low power consumption rate and a prolonged operation time can be achieved for a notebook-sized personal computer if it is adapted to use a magnetic disk 1 comprising a magnesium-made disk substrate 2. To summarize, while metal materials that can be used for a disk substrate 2 for the purpose of the invention include magnesium, aluminum, titanium, nickel and iron, the metal material of the disk substrate 2 preferably contains at least magnesium or aluminum, more preferably magnesium. It should be noted, however, that pure magnesium is highly reactive and ignitable and hence magnesium alloy is normally used. Magnesium alloy typically contains Mg by 83 to 97 wt %, Al by 3.5 to 10 wt % and Zn by 1.5 wt %, the balance being Mn.

It should also be noted that titanium, glass, nickel and iron may also suitably be used for the disk substrate of a magnetic disk according to the invention like aluminum and magnesium if materials with a high melting point become to be feasibly used for injection molding as a result of technological developments in the field of injection -molding. If the days come when such materials are suitably be used for injection molding for the purpose of the invention, 100% pure iron and aluminum are highly reactive and hence one or more than one impurities are preferably added to them in order to improve the anti-corrosiveness and the anti-ignitability of the materials.

As discussed above, the disk substrate 2 of a magnetic disk 1 according to the invention is made of metal and hence shows a satisfactory hardness level so that it provides a strength far better than any known resin disk substrates.

As a result, the disk substrate 2 of a magnetic disk 1 according to the invention is structurally less affected by any external vibrations. The disk substrate 2 shows a high resonance frequency and hardly resonates with an external vibration.

Thus, a magnetic disk 1 comprising such a disk substrate 2 would not easily vibrate if a vibration is externally applied thereto so that the magnetic head mounted on the flying slider will be properly placed in position on the right tack of the magnetic disk 1 to correctly retrieve the information signals recorded there. Then, the magnetic disk unit comprising such a magnetic disk 1 will show improved information recording/reproducing characteristics to realize a high recording density.

Additionally, since a disk substrate 2 according to the invention is produced by injection molding a metal material as defined above, the disk substrate does not require any polishing step using conventional polishing techniques in the manufacturing process to make the molding simple and less costly. As a result, a magnetic disk 1 comprising such a disk substrate 2 according to the invention can be manufactured at low cost.

Now, a magnetic disk 1 according to the invention is realized by forming a magnetic film 3 on such a disk substrate 2. The magnetic film 3 is made of a known magnetic layer forming material such as γ—Fe₂O₃, Co—γ—Fe₂O₃ or Co—Pt—Cr and produced on the disk substrate 2 by means of a known thin film forming technique such as sputtering.

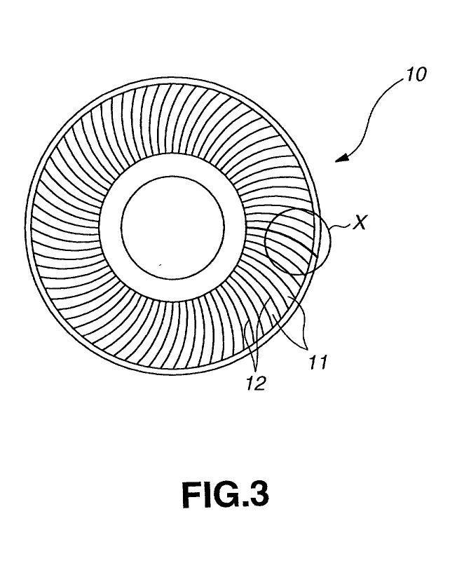

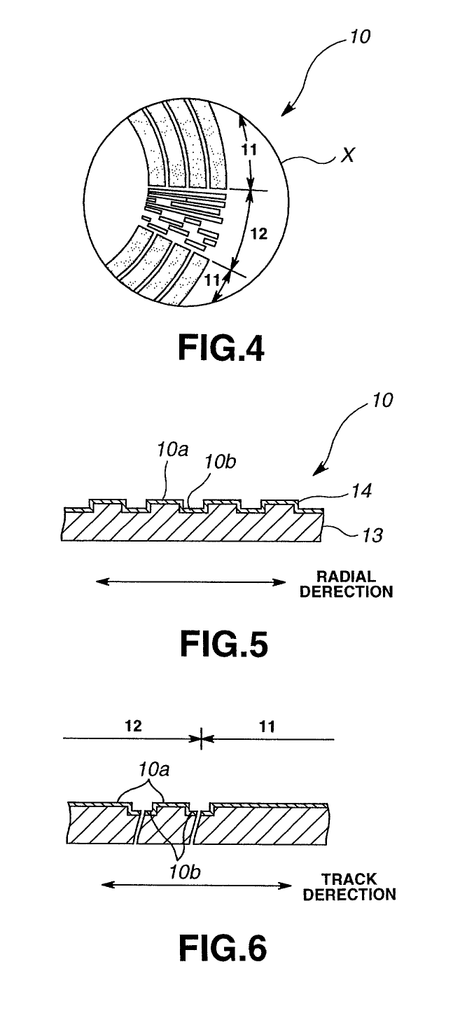

A magnetic disk realized by applying the present invention may be a magnetic disk 1 having a smoothed surface as described above or, alternatively, a magnetic disk 10 having a pattern of undulations running substantially along the tracks on the disk surface s shown in any of FIGS. 3 through 6. FIG. 3 is a schematic plan view of another magnetic disk 10 realized by applying the present invention and FIG. 4 is an enlarged schematic plan view of the circled area X of the magnetic disk 10 of FIG. 3. FIG. 5 is a schematic cross sectional view of part of the magnetic disk 10 of FIG. 3 taken along a radial direction of the disk. FIG. 6 is a schematic cross sectional view of part of the magnetic disk 10 of FIG. 6 taken along the direction of the tracks.

The disk substrate 13 of the magnetic disk 10 is formed in injection molding a metal material as in the case of the disk substrate 2 of the above described magnetic disk 1. As a matter of fact, the disk substrate 13 carries thereon patterns of undulation corresponding to respective data recording regions (data zones) 11 and ones corresponding to respective control signal recording regions 12 and a magnetic film 14 is formed on the surface t (servo zones) hereof. The data zones 11 and the servo zones 12 are arranged in such a way that servo zones 12 appear at regular intervals during a signal recording or reproducing operation. For example, the servo zones 12 may be arranged substantially radially from the center of the magnetic disk 10 as shown in FIG. 3.

In each of the data zones 11, data tracks for recording data and guards bands for separating adjacently located data tracks are coaxially arranged. In the magnetic disk 10, the data tracks provide ridges 10a and the guard bands provide grooves 10b to produce patterns of undulations. It suffices that the ridges and the grooves run in parallel with the direction along which the head slider flies over the magnetic disk 10. For example, if the recording tracks are spirally arranged, they are arranged also spirally along the recording tracks. The ridges 10a may be arranged continuously in a peripheral direction or may be separated by gaps to an extent that may not adversely affect the running head slider.

In the servo zones 12, on the other hand, gray codes for specifying data tracks, clock marks providing references for generating servo clocks and servo patterns including wobbled marks to be used for controlling the tracking operation of the magnetic head are recorded. The servo zones 12 are also provided with ridges 10a and grooves 10b that are magnetized in opposite directions to record the servo patterns.

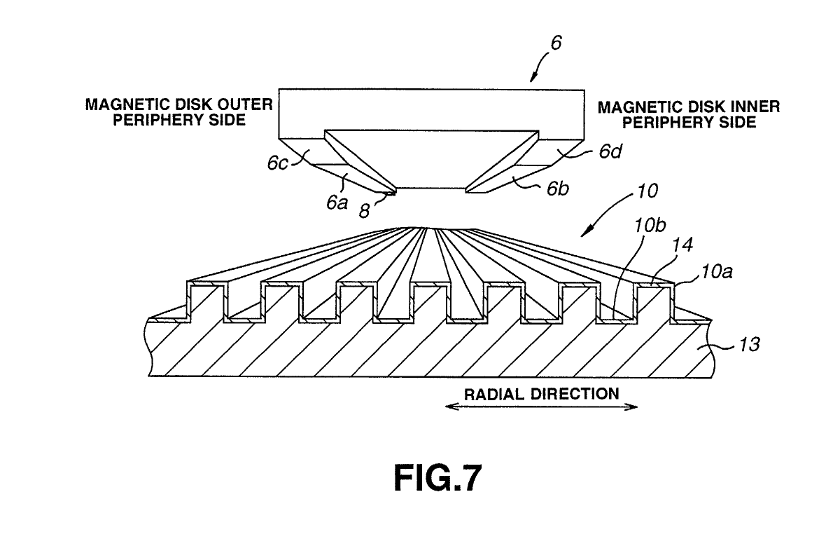

Then, the head slider 6 flies over the magnetic disk 10 having a configuration as described above in a data recording or reproducing operation as shown in FIG. 7. FIG. 7 is a schematic perspective view of part of the magnetic disk of FIG. 3, illustrating how the head slider 6 flies over the magnetic disk.

Referring to FIG. 7, the head slider 6 comprises a pair of rails 6a, 6b arranged respectively along the opposite lateral edges of the bottom surface thereof and adapted to operate as air bearing surfaces. The rails 6a, 6b are provided with respective tapered sections 6c, 6d at the front ends thereof. A magnetic head 6 is mounted on the rear surface of one of the rails, or rail 6a.

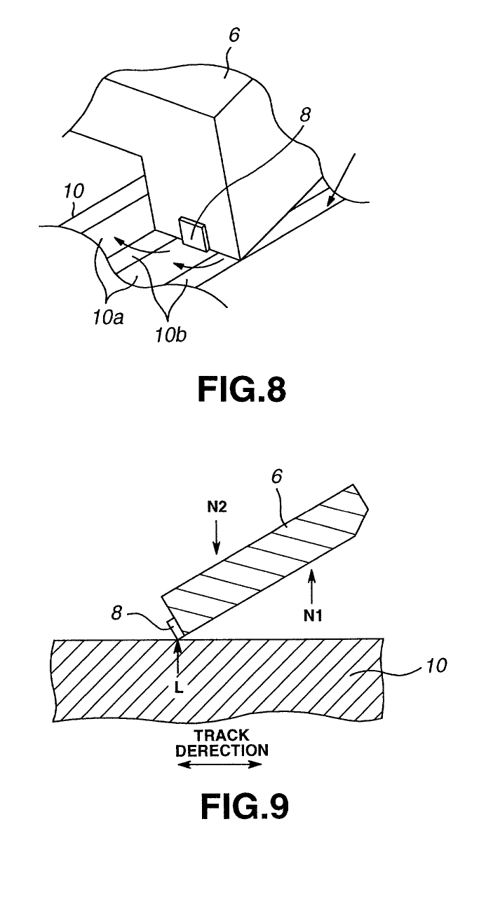

FIG. 8 is a schematic perspective view of a principal portion of the head slider 6 flying over the magnetic disk 10. FIG. 9 is a schematic cross sectional view of the head slider 6, illustrating the force to which it is subjected to in the state of FIG. 8.

As shown, the magnetic disk 10 are provided on the surface thereof with predetermined patterns of undulations. Therefore, air flows through the minute gaps between the grooves 10b on the magnetic disk 10 and the rear end sides of the rails 6a, 6b of the head slider 6. The flowing air generates buoyancy for lifting the head slider 6 into the air to make the latter fly over the magnetic disk 3, although the gap between the head slider 6 and the ridges 3a of the magnetic disk 3 can be reduced and made infinitely close to 0.

In other words, with the above described magnetic disk 10, the head slider 6 comes very close to the ridges 10a formed on the surface of the magnetic disk 10 when the head slider 6 flying over the recording medium shows a flying height equal to the distance normally separating a conventional head slider and a conventional magnetic disk having a flat surface. As the flying height of the head slider 6 flying over the magnetic disk 10 of FIG. 7 is reduced in this way, the distance between the ridges 10b on the magnetic disk 10 and the head slider 6 can be made to become infinitesimally close to 0.

Thus, with the above described magnetic disk 10, it is possible to record information signals on the ridges 10a at an enhanced density and minimize the spacing loss so as to boost the density of recorded information signals.

As the flying height of the head slider 6 flying over the magnetic disk 10 is made infinitesimally close to 0, the magnetic head 8 can eventually be brought into contact with the ridges 10a of the magnetic disk 10 in a loadless fashion. Then, the magnetic head 8 and the magnetic disk 10 are completely protected against abrasion if the magnetic head 8 is held in contact with the surface of the magnetic disk 10.

Thus, with such a head slider 6 and a magnetic disk 10, air flowing in from the tapered sections 6c, 6d along the rails 6a, 6b is forced to flow out through minute gaps between the grooves 10b of the magnetic disk 10 and the rear end sides of the rails 6a, 6b when the magnetic head 8 is held in contact with the magnetic disk 10 so that, as shown in FIG. 9, buoyancy N1 is generated for the head slider 6, trying to lift the head slider 6 in the right flying direction. Therefore, the vertical reaction L of the ridges 10a of the magnetic disk 10 to the magnetic head 8 is reduced to 0 to nullify the frictional force between the magnetic head 8 and the surface of the magnetic disk 10 if the buoyancy N1 and the load N2 of the head slider 6 are made to balance with each other. Then, the magnetic head 8 will be brought into contact with the ridges 3a of the magnetic disk 10 in a loadless fashion to eliminate any friction between the magnetic head 8 and the magnetic disk 10.

It should be noted here that any recording medium will fall within the scope of the present invention if it comprises a disk substrate formed by injection molding a metal material and a recording film formed on the disk substrate. Thus, a recording medium according to the invention may be an optical disk adapted to write information signals thereon in advance by means of embossed bits or a phase change type optical disk adapted to write information signals thereon by utilizing phase changes of the recording film or a magneto-optical disk adapted to write information signals thereon by utilizing the magneto-optical effect of the recording film, if it is not a magnetic disk such as magnetic disk 1 or 10 described above.

Specifically speaking, a magneto-optical disk according to the invention comprises a disk substrate 2 and a magneto-optical recording layer formed on the disk substrate 2 and adapted to lose its coercive force to reverse its direction of magnetization toward the outward magnetic field when the temperature rises above the Curie temperature. The magneto-optical recording layer typically comprises a thin film of an amorphous alloy such as Tb—Fe—Co, which is a vertically magnetized film showing the magneto-optical effect including the Kerr effect and/or the Faraday effect.

A phase change type optical disk according to the invention, on the other hand, comprises a disk substrate 2 and a phase change layer of a phase change material formed on the disk substrate 2 and adapted to reversibly change its phase between a crystal phase and an amorphous phase. Materials that can be used for the phase change material of the phase change layer include chalcogen type materials such as elements of Te and Se, Ge—Sb—Te, Ge—Te, In—Sb—Te, In—Se—Te—Ag, In—Se, In—Se—Tl—Co, In—Sb—Se, Bi₂Te₃, BiSe, Sb₂Se₃ and Sb₂Te₃.

A magneto-optical disk according to the invention may be an optical disk to be used with an optical disk unit realized by incorporating a recording/reproduction system to be used for magneto-optical disks into a hard disk unit. In other words, a magneto-optical disk according to the invention may be applied to an optical disk unit realized by incorporating a recording/reproduction system to be used for magneto-optical disks into a hard disk unit.

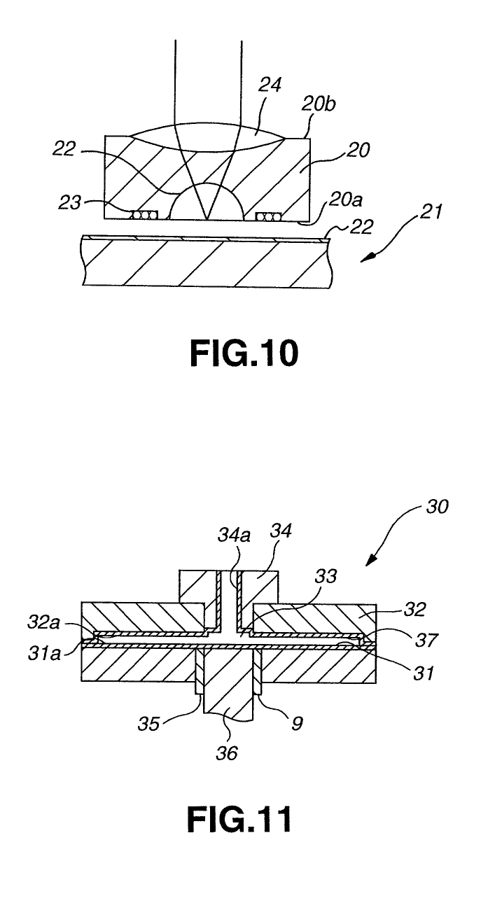

Such an optical disk unit is adapted to high density recording and realized by arranging the objective lens of an optical disk on a head slider and holding the objective lens and a magneto-optical disk in close proximity or in contact to raise the numerical aperture NA. FIG. 10 is a schematic cross sectional view of the head slider of an optical disk unit realized by incorporating a recording/reproduction system to be used for magneto-optical disks into a hard disk unit.

More specifically, referring to FIG. 10, the optical disk unit comprises a flying head slider 20 like its counterpart of a hard disk unit and the recording film 22 of the magneto-optical disk 21 is exposed to the surface of the disk as in the case of a hard disk.

Note, however, that it is not a magnetic recording/reproduction device but an optical module comprising lenses and coils for magneto-optical recording that is mounted on the flying head slider 20.

Thus, in such a optical disk unit, a prefocusing lens 24 is arranged on the surface 20b of the head slider 20 opposite to the surface 20a facing the disk and a semispherical solid immersion lens (to be referred to SI lens hereinafter) is mounted on the surface 20a facing the disk of the head slider 20. The prefocusing lens 24 operates as the objective lens of a known magneto-optical disk unit. The SI lens 22 is made of a material showing a high absolute refractive index such as glass.

A magnetic field modulation coil 23 is arranged to surround the SI lens 22 and used to invert the magnetic field near the SI lens 22 in order to produce recording marks.

An magneto-optical recording/reproduction system utilizing a magnetic filed modulation technique similar to the one used in mini-disks are used for recording/reproduction system of such an optical disk unit. Thus, the temperature of the recording film 22 is temporarily raised within the beam spot by laser irradiation and the direction of magnetization applied to the coil 23 is recorded when the film is cooling.

Now, a method of manufacturing a magnetic disk 1 according to the invention and having a configuration as described above will be discussed below.

Firstly, a disk substrate 2 is prepared by means of the metal mold 30 of an injection molding apparatus in a manner as will be described below. FIG. 11 is a schematic cross sectional view of the metal mold 30 of such an injection molding apparatus for manufacturing a disk substrate 2.

The metal mold 30 has a movable mold half 31 for producing one of the principal surfaces of the molded product and a stationary mold half 32 arranged oppositely relative to the movable mold half 31 to produce the other principal surface of the molded product.

The movable metal mold half 31 is driven to move away from the stationary mold half 32 and come back to contact the latter by means of a drive mechanism (not shown). Thus, when the movable mold half 31 and the stationary mold half 32 are put together and held in tight contact with each other to completely close the metal mold, they cooperates to define a cavity 33 for molding a disk substrate 2.

Meanwhile, the stationary metal mold half 32 is provided with a sprue bush 34 arranged at the center of the cavity 33 and having a nozzle 34a for injecting molten plastic into the cavity 33 to fill the latter. On the other hand, the movable mold half 31 is provided with an axially movable ejector member 35 arranged also at the center of the cavity 33 and having a hollow cylindrical profile with an outer diameter corresponding to the inner peripheral region of the disk substrate 2 where no information signals will be recorded. When the molded disk substrate 2 is taken out of the metal mold, the ejector member 35 is driven into the cavity 33 to separate the molded disk substrate 2 from the movable mold half 31 by a drive means (not shown). A punch 36 for punching out a center hole from the disk substrate to be molded is fitted to the inner periphery of the ejector member 35.

In a metal mold 30 to be used for the purpose of the invention, the inner lateral surface of the movable mold half 31, that of the stationary mold half 32, that of the nozzle 34a and the surface of the sprue bush 34 to be held in contact with the molded product are coated with an iridium film 37 that is highly heat-resistive. Therefore, when molten metal is injected through the nozzle 34 into the cavity 33 of the metal mold 34 to heat the inside of the metal mold 30 to very high temperature, the molding surface of the metal mold 30 is protected against any possible deformation thereof that can be caused by the heat of the molten metal.

The reason why an iridium film 37 is used for the coating is that iridium has a high melting point of 2,400° C. and is very hard so that the iridium film 37 will hardly be deformed by heat if molten metal having a high melting point such as magnesium is filled into the cavity and therefore the inner lateral surface of the movable mold half 31 and that of the stationary mold half 32 that define the cavity 33 will satisfactorily be protected.

When manufacturing a magnetic disk 10 according to the invention and having undulations on the surface, the metal mold 30 of an injection molding apparatus adapted to mold a disk substrate for the magnetic disk 10 typically comprises a movable mold half 31 and a stationary mold half 32 having their molding surfaces coated with an iridium film 37 and physically etched to produce patterns of undulations that are reversals of the respective patterns of undulations to be formed on the disk substrate. Thus, such a disk substrate can be molded for a magnetic disk 10 by means of an injection molding apparatus comprising a metal mold that carries patterns of undulations formed on the molding surfaces.

The reason of directly forming patterns of undulations on the molding surfaces of the movable mold half 31 and the stationary mold half 32 that are coated with an iridium film 37 by etching is described below.

Conventionally, when forming a resin disk substrate carrying thereon patterns of undulations, a stamper carrying thereon reversals of the patterns is arranged on the molding surface of the movable mold half or that of the stationary mold half of the metal mold of an injection molding apparatus and used to produce the disk substrate. Since such a conventional stamper is a very thin metal plate with a thickness of about 0.3 mm, it can easily be thermally expanded and deformed to make it impossible to produce an intended plane surface on the disk substrate when very hold molten metal is poured into the metal mold 30 for the purpose of the invention.

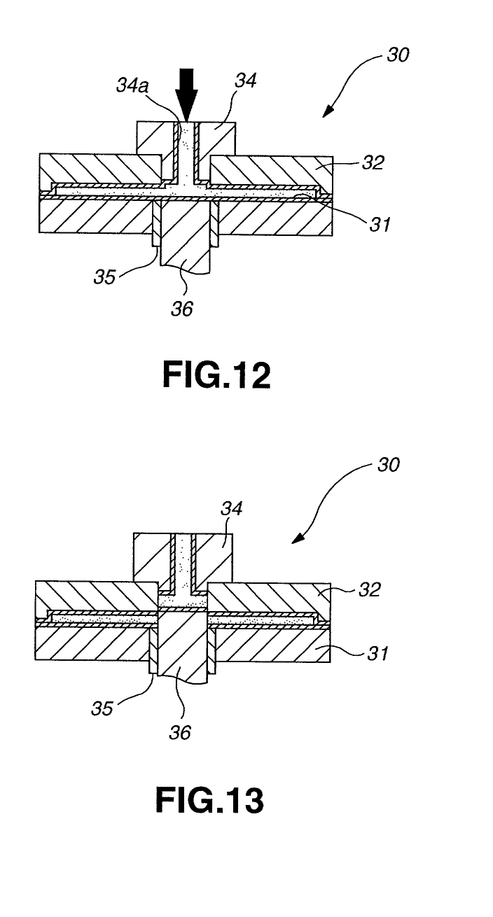

Now, a disk substrate 2 is injection molded in a manner as described below by means of an injection molding apparatus having the above described configuration. The steps of molding a disk substrate 2 will be described particularly in terms of the metal mold 30 of the injection molding apparatus. FIGS. 11 through 16 are schematic cross sectional views of the metal mold, illustrating different injection molding steps.

Firstly, as shown in FIG. 11, the movable mold half 31 is driven to move toward the stationary mold half 32 by means of a drive mechanism (not shown) until the metal mold is completely closed, when the movable mold half 31 and the stationary mold half 32 cooperates to define a closed cavity 33.

Then, molten metal that may typically be magnesium alloy is injected into the closed cavity 33 through the nozzle 34a in the sprue bush 34 until the cavity 33 is completely filled with molten metal. Note that the rate of injecting molten metal of this injection molding apparatus is made greater than that of injecting resin into the metal mold of a comparable known injection molding apparatus.

This is because, since a metal material to be used for a disk substrate for the purpose of the invention shows a thermal conductivity higher than a resin material as seen from Table 1 above, the metal material will be cooled by the relatively cold metal mold before the latter is completely filled with metal to make it impossible to produce an intended disk substrate if such a material is injected into the metal mold in a molten state at a rate equal to the rate of injecting a resin material.

Particularly, when magnesium alloy is used for injection molding, the rate of injection is made equal to about ten times of the rate of injection resin. This is because the thermal conductivity of magnesium is about 100 times greater than that of resin and requires such a high injection rate.

Then, the magnesium alloy filled into the cavity 33 is cooled to a half-molten state by means of a temperature control system (not shown) arranged at the metal mold of the injection molding apparatus and then, as shown in FIG. 13, the punch 36 is pushed toward the stationary mold half 34 through the center hole of the ejector member 35 to cut a center hole through the disk substrate that is being molded.

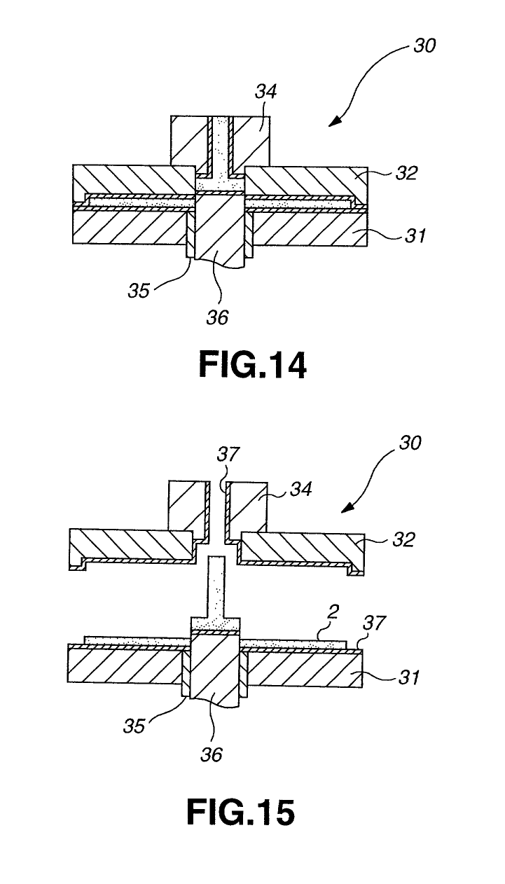

Subsequently, as shown in FIG. 14, the magnesium alloy filled in the cavity of the metal mold of the injection molding apparatus is cooled further and solidified by means of the temperature control system (not shown). Note that, at this stage, the metal mold 30 does not need to be cooled to the conventional low temperature level used for cooling the resin material in the metal mold. Specifically speaking, in the case of conventional injection molding using a resin material, the metal mold is cooled to about 100° C. On the other hand, all the metals listed in Table 1 above as candidate materials that can be used for the purpose of the invention have a melting point by far higher than that of resin. Therefore, in the case of magnesium alloy, the metal mold 30 may well be cooled to about 200° C. because the magnesium alloy in the metal mold 30 is sufficiently solidified when the metal mold 30 is cooled to this temperature level.

Then, as shown in FIG. 15, the movable mold half 31 is driven to move away from the stationary mold half 32 by a drive mechanism (not shown) in order to open the metal mold 30 of the injection molding apparatus. While the molded disk substrate may not have been cooled to room temperature when the metal mold 30 is opened, it will be quickly cooled to room temperature thereafter because the metal material of the disk substrate has a very high thermal conductivity.

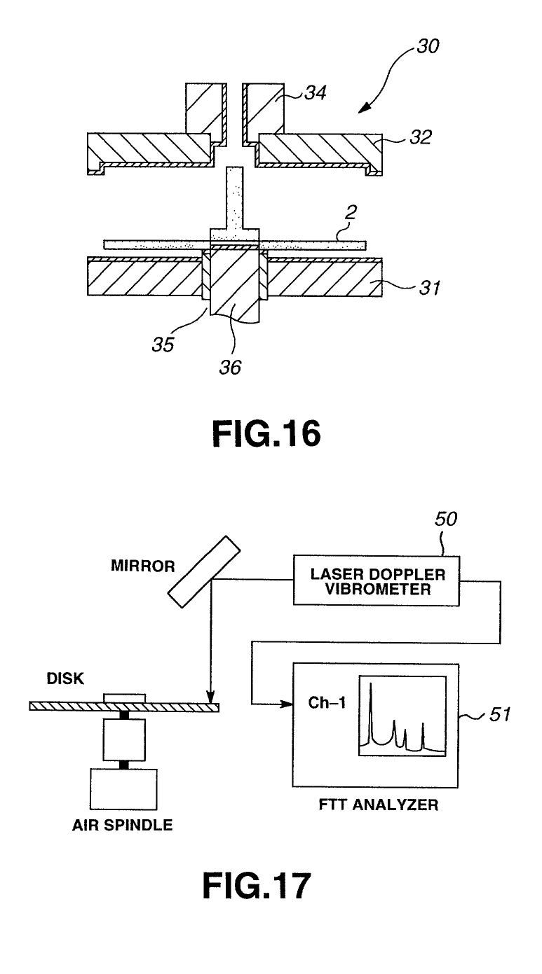

Finally, as shown in FIG. 16, the molded disk substrate 2 in the cavity 33 is pushed out from the movable mold half 31 by the ejector member 35 and taken out from the metal mold by means of a substrate delivery system (not shown).

The thixo-molding technique using a mixture of the solid phase and the liquid phase of magnesium alloy is employed for the above described injection molding process. The thixo-molding technique is a technique that is currently popularly used for injection molding using high melting point materials.

Thereafter, a magnetic film 3 of a known magnetic material such as γ—Fe₂O₃, Co—γ—Fe₂O₃ or Co—Pt—Cr is formed on the prepared disk substrate 2 by means of a known thin film forming technique such as sputtering to produce a final product of magnetic disk 1.

A protection film may be formed on the magnetic film 3 by using carbon as raw material and by means of a known thin film forming technique such as sputtering. Additionally an underlying film may be formed between the disk substrate 2 and the magnetic film 3 by using Cr as raw material and by means of a known thin film forming technique such as sputtering.

### EXAMPLES

Now, the present invention will be described by way of specific examples and some of the results of the observations made for the examples. More specifically, the effect of the material of each of the disk substrates prepared in the examples on the vibration characteristics of the magnetic disk comprising the disk substrate was observed in a manner as described below.

### Example 1

Magnesium that is considered to be practically advantageous among the materials listed in Table 1 above was used as the material of the disk substrate of this example.

Firstly, a magnesium alloy containing magnesium by 85 wt %, aluminum by 5 wt %, zink by 5 wt % and manganese by 5 wt % was prepared.

Then, an injection molding apparatus comprising a metal mold having the entire inner lateral surface thereof coated with iridium to protect it against the molded product was introduced and the molten magnesium alloy was injected into the metal mold by way of the nozzle until the cavity of the mold is filled with the material. The cavity of the metal mold was so dimensioned as to produce a disk substrate having an outer diameter of 95 mm, an inner diameter of 25 mm for a center hole and a thickness of 0.8 mm. The rate of injection was about 10 times of the rate of injecting a resin material in a similar injection molding apparatus.

Then, the magnesium alloy in the cavity was cooled to a half-molten state by means of the temperature control system of the metal mold and subsequently a center hold was cut through the disk substrate by pushing the punch of the metal mold.

Thereafter, the metal mold was cooled to the preselected temperature level of about 200° C. and then the metal mold was opened to take out the molded disk substrate from the mold by means of the disk delivery system (not shown) of the metal mold.

Then, an underlying lay of chromium (Cr), a magnetic layer of cobalt-chromium-platinum (Co—Cr—Pt) and a protection layer of carbon (C) were sequentially formed on the molded disk substrate by sputtering. Thereafter, a lubricating agent was applied onto the protection layer by means of a dipping technique to finally produce a magnetic disk having an outer diameter of 95 mm, an inner diameter of 25 mm for a center hold and a thickness of 0.8 mm.

### Example 2

A magnetic disk was prepared by following the process of Example 1 except the magnesium alloy was replaced by aluminum.

### Comparative Example

For the purpose of comparison, a magnetic disk was prepared by following the process of Example 1 except that the magnesium alloy was replaced by a resin material and the cavity was made to show a depth of about 1.2 mm to make the magnetic disk 1.2 mm thick.

<Evaluation of the Vibration Characteristics>

The vibration characteristics of each of the magnetic disks prepared in the above examples was tested to see the vibration characteristics. FIG. 17 is a schematic block diagram of the vibration measuring system used for the evaluation of the vibration characteristics of the specimens.

The vibration measuring system used for observing the vibration of each of the specimens of magnetic disk comprised a Laser Doppler Vibrometer 50 as shown in FIG. 17. An air spindle was used as the spindle of the system in order to eliminate any vibrations other than the one on the disk surface. All the components of the vibration that are synchronized with the revolution of the disk were removed as they were deemed to be attributable to the undulations of the disk per se. Thus, only the components of the vibration not synchronized with the revolution of the disk were observed.

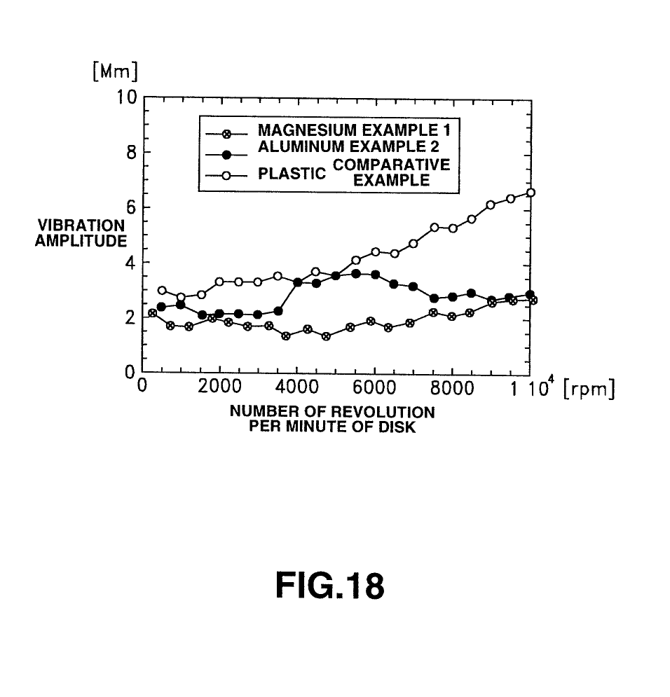

The signals obtained by the Laser Doppler Vibrometer 50 were then developed on the frequency axis by means of a fast Fourier transform analyzer 51 to remove the revolving components of the vibration of the disk and the sum of the squares of the remaining components of the vibration was obtained to indicate the vibration. Thus, the graph of FIG. 18 was obtained. In FIG. 18, the horizontal axis represents the frequency and the vertical axis represents the sum of the squares of the vibration components.

As seen from FIG. 18, the magnetic disk of Example 1 comprising a disk substrate made of a magnesium alloy of showed vibration characteristics substantially equal to those of the magnetic disk of Example 2 comprising a magnetic disk of aluminum. More rigorously speaking, the magnetic disk of Example 1 comprising the disk substrate of magnesium alloy showed a slightly less vibration than the magnetic disk of Example 2 comprising the magnetic disk of aluminum.

On the other hand, the magnetic disk of Comparative Example comprising the disk substrate of resin proved to vibrate remarkably when the disk is driven to rotate at a large number of revolution per minute and show vibration characteristics much poorer than the magnetic disks of Examples 1 and 2, although the disk substrate had a thickness significantly greater than its counterparts of Examples 1 and 2. It may be safe to assume that this is due to the small E/ρ value of the resin material that is smaller than that of aluminum or magnesium.

As clearly seen from the above examples, the strength of a disk substrate and the magnetic disk comprising such a disk substrate can be greatly enhanced if it is produced by injection molding a metal material to consequently make the magnetic disk to be less affected by external vibrations and show excellent vibration characteristics. Particularly, such a disk substrate is preferably made of magnesium alloy from the viewpoint of vibration characteristics.

Additionally, since the disk substrate of a magnetic disk according to the invention is produced by injection molding as in the case of Example 1 and 2, the process of polishing the disk substrate of a known disk substrate manufacturing method can be eliminated for the purpose of the invention to simply the manufacturing process and reduce the manufacturing cost.

* As described above in detail, since a recording medium substrate according to the invention and defined above is made of a metal material, it shows a sufficient hardness so that it is less affected by external vibrations and shows desired vibration characteristics. Additionally, since a recording medium substrate according to the invention is made of a metal material and formed by injection molding, it does not need a polishing step, unlike conventional substrates, and hence can be produced with a reduced number of molding steps at reduced cost.

Additionally, since a recording medium according to the invention and defined above comprises a substrate made of a metal material, it shows a sufficient hardness so that it is less affected by external vibrations and shows desired vibration characteristics. Additionally, since the substrate of a recording medium according to the invention is made of a metal material and formed by injection molding, it does not need a polishing step, unlike conventional substrates, and hence can be produced with a reduced number of molding steps at reduced cost.

1. A recording medium substrate characterized by being made of a metal material and formed by injection molding.

2. A recording medium substrate according to claim 1, wherein said metal material contains at least magnesium or aluminum.

3. A recording medium substrate according to claim 1, wherein predetermined patterns of undulations are formed on the surface thereof.

4. A recording medium characterized by comprising a substrate made of a metal material and formed by injection molding and a recording film formed on said substrate.

5. A recording medium according to claim 4, wherein said metal material contains at least magnesium or aluminum.

6. A recording medium according to claim 4, wherein predetermined patterns of undulations are formed on the surface of said substrate.
